(19) United States
(12) Patent Application Publication
(10) Pub. No.: US 2006/0001608 A1
(43) Pub. Date: Jan. 5, 2006

(54) Plasma display panel (PDP)

(76) Inventors: Kyoung-Doo Kang, Suwon-si (KR); Won-Ju Yi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/172,737

(22) Filed: Jun. 29, 2005

(30) Foreign Application Priority Data
Jun. 30, 2004 (KR) 10-2004-0050801
Jun. 30, 2004 (KR) 10-2004-0050803

(51) Int. Cl. G09G 3/28

(52) U.S. Cl. 345/67

(57) ABSTRACT

A plasma display panel (PDP) is disclosed. The PDP includes: a first substrate and a second substrate opposite to the first substrate, a barrier rib, partitioning discharge cells together with the first substrate and the second substrate, and made of a dielectric material, common-address electrode lines, embedded in the barrier rib to surround the discharge cells, and extending to cross the discharge cells, scan electrode lines, embedded in the barrier rib to surround the discharge cells, separated from the common-address electrode lines, and extending to intersect the common-address electrode lines at the respective discharge cells, phosphor layers formed in the discharge cells. In one embodiment, the PDP is driven by a driving waveform including a reset period, an address period, and a sustain-discharge period. In this embodiment, in the reset period, a rising ramp pulse is applied to the scan electrode lines to perform a first initialization discharge and a falling ramp pulse is applied to the scan electrode lines to perform a second initialization discharge, in the address period, a scan low voltage (V_{SC-L}) of a scan pulse is sequentially applied to a plurality of scan electrode lines which are maintained at a scan high voltage (V_{SC-H}) and a display data signal is selectively applied to common-address electrode lines intersecting the scan electrode lines to which the scan low voltage (V_{SC-L}) of the scan pulse is applied, and in the sustain-discharge period, an alternate sustain pulse is applied to the scan electrode lines, wherein a lowest voltage (V_{nf}) of the falling ramp pulse applied in the reset period is different from a voltage (Vₛ) of the alternate sustain pulse applied in the sustain-discharge period.

### CROSS-REFERENCE TO RELATED PATENT APPLICATIONS

This application claims the benefits of Korean Patent Applications No. 10-2004-0050801, filed on Jun. 30, 2004, and No. 10-2004-0050803, filed on Jun. 30, 2004, in the Korean Intellectual Property Office, the disclosures of which are incorporated herein in their entireties by reference.

### BACKGROUND OF THE INVENTION

1. Field of the Invention

The present invention relates to a plasma display panel (PDP), and more particularly, to a plasma display panel (PDP) capable of improving light-emitting efficiency and reducing a permanent afterimage.

2. Description of the Related Technology

A plasma display device with a plasma display panel (PDP) has a large screen with a wide viewing angle, is thin and light, and displays high quality pictures. Also, the PDP can be easily manufactured and scaled-up, compared to other flat panel displays (FPDs). For these reasons, a PDP is considered to be one of the next-generation FPDs.

The PDPs are classified into a DC-type, an AC-type, and a Hybrid-type according to a discharge voltage, and also into an opposite discharge type and a surface discharge type according to a discharge structure.

Generally, two-electrode opposite discharge PDPs have been actively investigated. However, in the two-electrode opposite discharge PDP, since a discharge is generated between a first substrate and a second substrate on which phosphor layers are formed, deterioration of the phosphor layers due to ion sputtering is very significant. In order to solve this problem, three-electrode surface discharge AC PDPs have been developed and are being widely used.

FIG. 1 is a perspective view of a conventional three-electrode surface discharge PDP 1. FIG. 2 is a block diagram of a plasma display device 100 including the PDP 1 shown in FIG. 1. Referring to FIGS. 1 and 2, common-address electrode lines A_{R1}, . . . , A_{Bm}, dielectric layers 11 and 15, Y electrode lines Y₁, . . . , Yₙ, X electrode lines X₁, . . . , Xₙ, phosphor layers 16, barrier ribs 17, and a MgO layer 12 as a protection layer are provided between first and second substrates 10 and 13 of the conventional three-electrode surface discharge PDP 1.

The common-address electrode lines A_{R1}, . . . , A_{Bm} are formed with a predetermined pattern on the upper surface of the second substrate 13. The lower dielectric layer 15 is formed to cover the entire upper surfaces of the address electrode lines A_{R1}, . . . , A_{Bm} and the second substrate 13. The barrier ribs 17 are formed in parallel to the address electrode lines A_{R1}, . . . , A_{Bm} on the surface of the first dielectric layer 15. The barrier ribs 17 partition discharge spaces of respective display cells and prevent cross-talk between the display cells. The phosphor layers 16 are respectively formed between the barrier ribs 17.

The X electrode lines X₁, . . . , X_{f} and Y electrode lines Y₁, . . . , Yₙ are formed with a predetermined pattern on the rear surface of the first substrate 10 made of, for example, glass, in a manner to intersect the address electrode lines A_{R1}, . . . , A_{Bm}. Discharge cells are formed at the intersections of the X electrode lines X₁, . . . , X_{f} and Y electrode lines Y₁, . . . , Yₙ with the address electrode lines A_{R1}, . . . , A_{Bm}. The second dielectric layer 11 is formed to cover the entire lower surfaces of the X electrode lines X₁, . . . , X_{f} and Y electrode lines Y₁, . . . , Yₙ and the first substrate 10. A protection layer for protecting the PDP 1 from a strong electric field, for example, the MgO layer 12, is formed to cover the entire rear surface of the second dielectric layer 11. A discharge space 14 is filled with a plasma forming gas.

Referring to FIG. 2, the plasma display apparatus 100 includes an image processor 56, a logic controller 62, an address driver 3, an X driver 4, and a Y driver 5. The logic controller 62 generates driving control signals SA, SY, and SX according to an internal image signal received from the image processor 56. The address driver 3, the X driver 4, and the Y driver 5, respectively, process an address signal SA, an X driving signal SX, and a Y driving signal SY received from the logic controller 62 and apply the processed signals to Y electrode lines.

FIG. 3 shows waveforms of PDP driving signals applied to electrodes of a PDP in a sub-field. A conventional resetting method included in the driving method illustrated in FIG. 3 is disclosed in Japanese Patent Publications Nos. 214,823 and 242,224 published in 2000.

Referring to FIG. 3, in a reset period PR of a sub-field SFₙ, a second voltage V_{T1} is first applied to Y electrodes Y₁, . . . , Yₙ and then a voltage gradually rising to a first voltage V_{T1}+V_{SET} greater than the second voltage V_{T1} by a fifth voltage V_{SET} is applied to the Y electrode lines Y₁, . . . , Yₙ. At this time, X electrodes X₁, . . . , Xₙ and address electrodes A₁, . . . , Aₘ are maintained at a ground voltage VG. Accordingly, a weak discharge is generated between the Y electrodes Y₁, . . . , Yₙ and the X electrodes X₁, . . . , Xₙ and a weaker discharge is generated between the Y electrodes Y₁, . . . , Yₙ and the address electrodes A₁, . . . , Aₘ. Thus, a large number of negative wall charges are formed near the Y electrodes Y₁, . . . , Yₙ, positive wall charges are formed near the X electrodes X₁, . . . , Xₙ, and a small number of positive wall charges are formed near the address electrodes A₁, . . . , Aₘ.

Then, a bias voltage Vₑ is applied to the X electrodes X₁, . . . , Xₙ. While the bias voltage Vₑ is applied, the voltage V_{T1}+V_{SET} applied to the Y electrodes Y₁, . . . , Yₙ falls to a third voltage V_{T2} and a voltage gradually falling to a fourth voltage V_{nf} is applied to the Y electrode lines Y₁, . . . , Yₙ. At this time, the address electrodes A₁, . . . Aₘ are maintained at the ground voltage VG. Accordingly, a weak discharge is generated between the X electrodes X₁, . . . , Xₙ and the Y electrodes Y₁, . . . , Yₙ, and a portion of the negative wall charges formed near the Y electrodes Y₁, . . . , Yₙ is moved near the X electrodes X₁, . . . , Xₙ due to the weak discharge. Thus, a wall voltage of the X electrodes X₁, . . . , Xₙ becomes less than that of the address electrodes A₁, . . . , Aₘ and greater than that of the Y electrodes Y₁, . . . , Yₙ.

Accordingly, it is possible to lower an addressing voltage V_{A}−V_{SC-L} required for an opposite discharge between address electrodes and Y electrodes selected in a following addressing period PA. Meanwhile, since all the address electrodes A₁, . . . , Aₘ are maintained at the ground voltage VG, the address electrodes A₁, . . . , Aₘ are discharged with respect to the X electrodes X₁, . . . , Xₙ and the Y electrodes Y₁, . . . , Yₙ, and the positive wall charges formed near the address electrodes A₁, . . . , Aₘ are erase-discharged.

Successively, in an address period PA, while the bias voltage Vₑ is being applied to the X electrodes X₁, . . . , Xₙ, a display data signal is applied to the address electrodes A₁, . . . , Aₘ, and a scan pulse of a scan low voltage V_{SC-L} is sequentially applied to Y electrodes biased to a sixth voltage V_{SC-H} less than the second voltage V_{T1}, so as to perform stable addressing. At this time, a display data signal V_{A} with a positive polarity is applied to the address electrodes A₁, . . . , Aₘ to select display cells and the remaining display cells maintained at the ground voltage VG are not selected. Accordingly, if a display data signal of a positive addressing voltage VA is applied to Y electrodes to which the scan pulse of the scan low voltage V_{SC-L} is applied, wall charges are formed in corresponding display cells due to address discharge and no wall charge is formed in the remaining display cells.

Thereafter, in a sustain-discharge period PS, a sustain pulse with a sustain voltage Vₛ is alternately applied to all the Y electrodes Y₁, . . . , Yₙ and all the X electrodes X₁, . . . , Xₙ, so as to generate display-sustain discharge in the display cells in which wall charges have been formed during the addressing period PA.

However, in the PDP 1 with the structure in which the electrode lines, the second dielectric layer 11, and the protection layer 12 are sequentially formed on the rear surface of the first substrate 10, about 40% of visible light emitted from the phosphor layers 16 is absorbed, which deteriorates light-emitting efficiency. If the same image is displayed for a long time, charged particles in the discharge gas cause ion-sputtering of the phosphor layers 16 due to an electric field, resulting in leaving a permanent afterimage and reducing the lifetime of the PDP. Also, since three drivers (that is, the X driver 4, the Y driver 5, and the address driver 3) are required to drive the PDP 1, the structure of the PDP 1 is complicated and manufacturing cost of the drivers and a power supply circuit therefor increases.

### SUMMARY OF CERTAIN INVENTIVE ASPECTS

One aspect of the present invention provides a plasma display panel (PDP) capable of improving light-emitting efficiency and reducing a permanent afterimage, and a driving method thereof.

Another aspect of the present invention provides a plasma display panel (PDP), comprising: a first substrate and a second substrate opposite to the first substrate, a barrier rib, partitioning discharge cells together with the first substrate and the second substrate, and made of a dielectric material, common-address electrode lines, embedded in the barrier rib to surround the discharge cells, and extending to traverse the discharge cells, scan electrode lines, embedded in the barrier rib to surround the discharge cells, separated from the common-address electrode lines, and extending to intersect the common-address electrode lines at the respective discharge cells, phosphor layers formed in the discharge cells, and wherein the PDP is driven by a driving waveform including a reset period, an address period, and a sustain-discharge period, in the reset period, applying a rising ramp pulse to the scan electrode lines to perform first initialization discharge and applying a falling ramp pulse to the scan electrode lines to perform second initialization discharge, in the address period, sequentially applying a scan low voltage V_{SC-L} of a scan pulse to a plurality of scan electrode lines which are maintained at a scan high voltage V_{SC-H} and selectively applying a display data signal to common-address electrode lines intersecting the scan electrode lines to which the scan low voltage V_{SC-L} of the scan pulse is applied, and in the sustain-discharge period, applying an alternate sustain pulse to the scan electrode lines, wherein a lowest voltage V_{nf} of the falling ramp pulse applied in the reset period is different from a voltage Vₛ of the alternate sustain pulse applied in the sustain-discharge period.

In one embodiment, the magnitude of the lowest voltage V_{nf} applied in the reset period is greater than the voltage Vₛ of the alternate sustain pulse applied in the sustain-discharge period.

In one embodiment, in the reset period, a bias voltage Vₐ with the same voltage as that of the display data signal is applied to the common-address electrode lines when the falling ramp pulse is applied to the scan electrode lines. In one embodiment, the magnitude of the lowest voltage V_{nf} of the falling ramp pulse is smaller than the magnitude of the scan low voltage V_{SC-L} of the scan pulse sequentially applied to the scan electrode lines in the address period.

In one embodiment, a strong discharge is generated in the discharge cells when the sum of a wall voltage created by wall charges accumulated on the barrier rib and a voltage difference between a signal applied to the common-address electrodes and that applied to the scan electrodes, exceeds a characteristic discharge start voltage V_{f} of the discharge cells, and a characteristic discharge start voltage of the reset period, a characteristic discharge start voltage of the address period, and a characteristic discharge start voltage of the sustain-discharge period are all the same. In one embodiment, in the sustain-discharge period, the voltage Vₛ of the alternate sustain pulse applied to the scan electrode lines is greater than half the characteristic discharge start voltage V_{f}.

In one embodiment, the falling ramp pulse applied to the scan electrodes in the reset period has a slope generating the second initialization discharge while a all voltage, greater by the characteristic discharge start voltage V_{f} than the voltage f the falling ramp pulse, is maintained.

In one embodiment, after the falling ramp pulse is terminated, the discharge cells are maintained at an after reset wall voltage V_{w} greater by the characteristic discharge start voltage V_{f} than the magnitude of the lowest voltage V_{nf} of the falling ramp pulse.

In one embodiment, the after reset wall voltage Vw is less than half the characteristic discharge start voltage V_{f}.

In one embodiment, the sum of the after reset wall voltage V_{w} and the voltage Vₛ of the alternate sustain pulse is less than the characteristic discharge start voltage V_{f}.

In one embodiment, the common-address electrode lines and the scan electrode lines of the PDP are made of a conductive material and are formed in a ladder shape.

### BRIEF DESCRIPTION OF THE DRAWINGS

Embodiments of the present invention will be described with reference to the attached drawings.

FIG. 1 is a perspective view of a conventional three-electrode surface discharge plasma display panel (PDP).

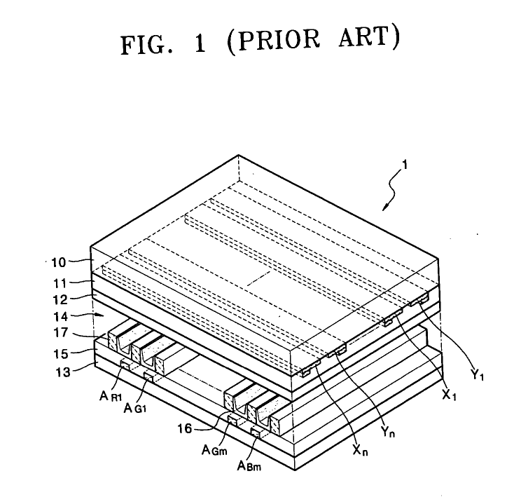

FIG. 2 is a block diagram of a plasma display device including the PDP illustrated in FIG. 1.

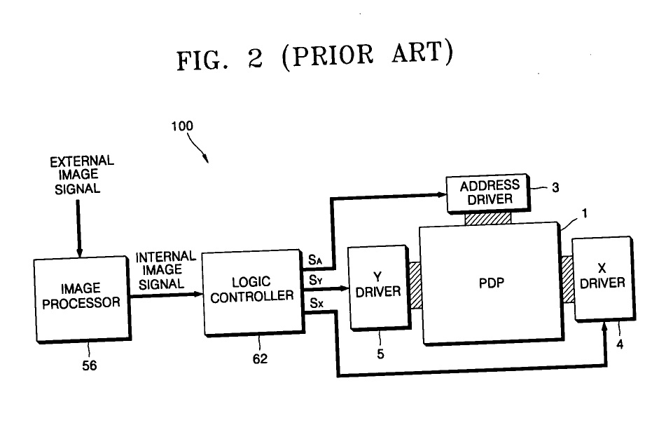

FIG. 3 shows waveforms of driving signals for driving the PDP illustrated in FIG. 1.

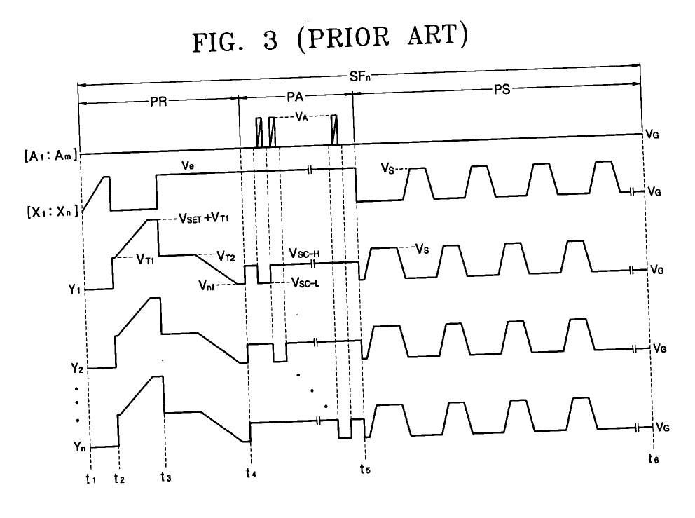

FIG. 4 is a partially exploded perspective view of a PDP according to an embodiment of the present invention.

FIG. 5 is a cross-sectional view of the PDP taken along a line IV-IV in FIG. 4.

FIG. 6 is a schematic diagram of an arrangement of common-address electrode lines A₁-Aₙ, taken along a line V-V in FIG. 5.

FIG. 7 is a schematic diagram of an arrangement of scan electrode lines S₁-Sₘ, taken along a line VI-VI in FIG. 5.

FIG. 8 is a block diagram of a plasma display device including the PDP illustrated in FIG. 4.

FIG. 9 is a timing diagram for explaining an embodiment of a driving method of the PDP illustrated in FIG. 4.

FIG. 10 shows waveforms of signals applied to electrode lines of the PDP illustrated in FIG. 4 in a sub-field of FIG. 9.

FIG. 11 is a view for explaining waveforms of signals applied to electrode lines of the PDP illustrated in FIG. 4 in a sub-field and wall voltage distributions of turned-on cells and turned-off cells, according to an embodiment of a driving method of the PDP illustrated in FIG. 4.

FIG. 12 is a view for explaining waveforms of signals applied to electrode lines in a sub-field and wall voltage distributions of turned-on cells and turned-off cells, according to another embodiment of a driving method of the PDP illustrated in FIG. 4.

### DETAILED DESCRIPTION OF CERTAIN INVENTIVE EMBODIMENTS

Embodiments of the present invention will now be described more fully with reference to the accompanying drawings, in which exemplary embodiments of the invention are shown.

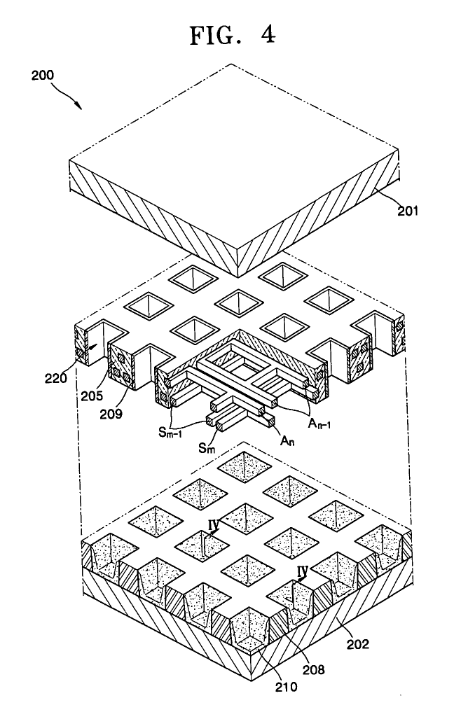

Hereinafter, embodiments of the present invention will be described in detail with reference to FIGS. 4 through 12.

As shown in FIGS. 4 through 7, a plasma display panel (PDP) 200 according to an embodiment of the present invention includes: a first substrate 201, a second substrate 202 opposite to the first substrate 201, a first barrier rib 205, disposed between the first and second substrates 201 and 202, partitioning discharge cells 220 formed in conjunction with the first and second substrates 201 and 202, and made of a dielectric material, common-address electrode lines A₁, . . . , Aₙ embedded in the first barrier rib 205 to surround the discharge cells 220 and extending to traverse the discharge cells 220, scan electrode lines S₁, . . . , Sₘ embedded in the first barrier rib 205 and separated from the common-address electrode lines A₁, . . . , Aₙ, at the intersection of the discharge cells 220, wherein the respective discharge cells 220 are formed where the scan electrode lines S₁, . . . , Sₘ with the common-address electrode lines A₁, . . . , Aₙ, phosphor layers 210 formed in the discharge cells 220, and discharge gas filled in the discharge cells 220.

In one embodiment, The first substrate 201 is made of a material with high light permeability, such as glass. Since no electrode line exists on the first substrate 201, differently from a conventional first substrate on which electrode lines X₁ through Xₙ and Y₁ through Yₙ exist, the light permeability of visible light toward a front direction is greatly improved. Accordingly, when an image has the same brightness as in the conventional technique, the electrode lines X₁ through Xₙ and Y₁ through Yₙ are driven at a relatively low voltage, resulting in improving light emitting efficiency compared to the conventional technique.

The second substrate 202 is positioned in parallel to the first substrate 201. In one embodiment, the second substrate 202 is generally made of a material having glass as its main ingredient.

The first barrier rib 205 is formed between the first and second substrates 201 and 202, so as to partition a plurality of discharge cells 220. The first barrier rib 205 partitions the discharge cells 220 each of which is one of a red-emitting sub-pixel, a green-emitting sub-pixel, and a blue-emitting sub-pixel, and prevents a wrong discharge from being generated between the discharge cells 220.

In one embodiment, the first barrier rib 205 is made of a dielectric material which prevents direct conduction between the common-address electrode lines A₁ through Aₙ and the scan electrode lines S₁ through Sₘ, preventing charged particles from directly colliding with and damaging the electrodes, and accumulating the charged particles as wall charges, when a discharge is generated. In one embodiment, such a dielectric material includes PbO, B₂O₃, and SiO₂.

The common-address electrode lines A₁ through Aₙ and the scan electrode lines S₁ through Sₘ surrounding the discharge cells 220 are embedded in the first barrier rib 205. The common-address electrode lines A₁ through Aₙ intersect the scan electrode lines S₁ through Sₘ with a predetermined spacing from them. In one embodiment, the electrode lines A₁ through Aₙ and S₁ through Sₘ are made of a conductive material such as Al or Cu. Here, the common-address electrode lines A₁, . . . , Aₙ function as common-address electrodes and the scan electrode lines S₁, . . . , Sₘ function as scan electrodes.

In one embodiment, the common-address electrode lines A₁, . . . , Aₙ and scan electrode lines S₁, . . . , Sₘ are arranged in a ladder shape.

In one embodiment, MgO films 209 as protection films cover the lateral surfaces of the first barrier rib 205. The MgO films 209 prevent the charged particles from colliding with and damaging the first barrier rib 205 made of, for example, a dielectric material, and accelerate secondary electrons when a discharge is performed.

The PDP 200 according to one embodiment of the present invention can further include a second barrier rib 208 which is disposed between the first barrier rib 205 and the rear (second) substrate 202 to partition the discharge cells 220 together with the first barrier rib 205. In FIG. 4, the second barrier rib 208 is formed in a matrix pattern, however, it is not limited to this. The second barrier rib 208 can be formed in an open shape, such as a stripe pattern, or in a closed shape, such as a waffle pattern, a matrix pattern or a delta pattern. Also, the closed-type barrier rib can be formed so that the cross-section of each discharge space is a polygon, such as a triangle or a pentagon, a circle, an oval, etc., other than a square shown in the present embodiment. As shown in FIG. 4, in one embodiment, the first and second barrier ribs 205 and 208 can be formed in the same pattern. However, in another embodiment, it is also possible to form the first and second barrier ribs 205 and 208 in different patterns.

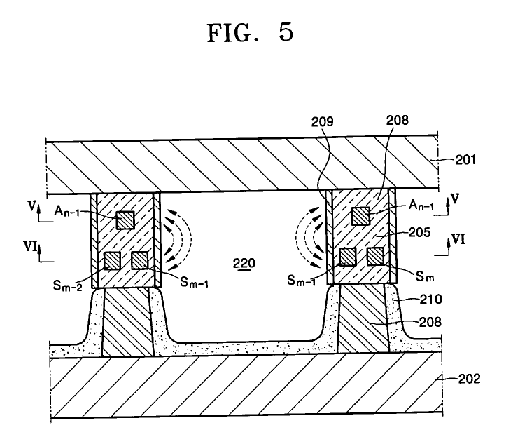

Referring to FIG. 5, the phosphor layers 210 are formed to cover the lateral surfaces of the second barrier rib 208 and the upper surfaces of the second substrate 202.

The phosphor layers 210 have components for receiving ultraviolet and emitting visible light, wherein phosphor layers formed on red-emitting sub-pixels include phosphors such as Y(V,P)O₄:Eu, phosphor layers formed on green-emitting sub-pixels include phosphors such as Zn₂SiO₄:Mn, YBO₃:Tb and so on, and phosphor layers formed on blue-emitting sub-pixels include phosphors such as BAM:Eu.

A discharge gas, such as Ne, Xe, Ne mixture, or Xe mixture, is filled in the discharge cells 220. According to one embodiment of the present invention, since an entire discharge area increases and more plasma is produced, low-voltage driving is realized. Also, according to one embodiment of the present invention, since low-voltage driving is obtained even when a high-density Xe gas is used as the discharge gas, light-emitting efficiency can be significantly improved. Thus, one embodiment of the invention can overcome a problem of the conventional PDP where it is difficult to realize low-voltage driving when high-density Xe gas is used as the discharge gas.

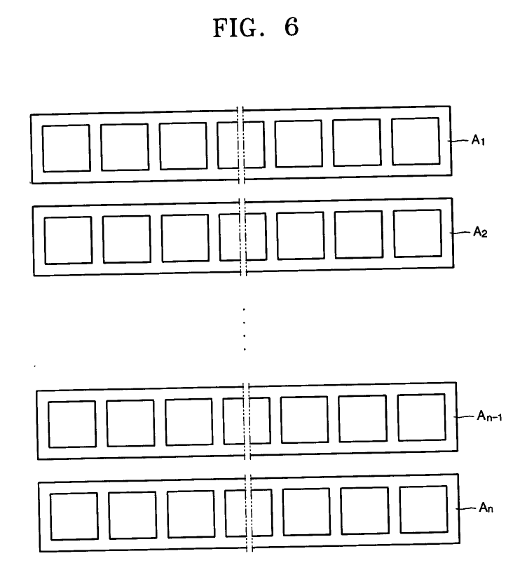

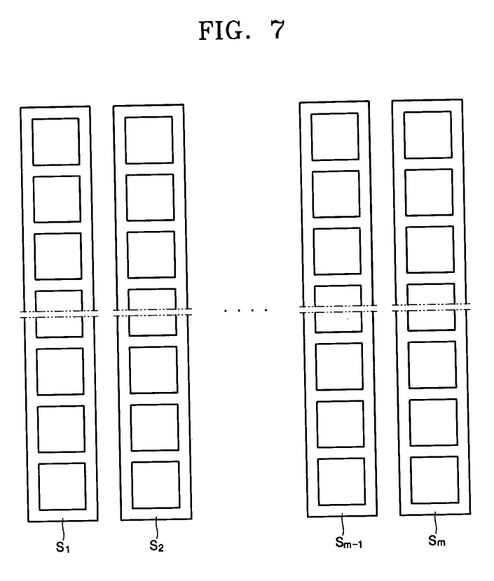

In one embodiment, the common-address electrode lines A₁ through Aₙ and the scan electrode lines S₁ through Sₘ are made of a conductive material and are formed in a ladder shape. FIG. 6 is a schematic diagram of an exemplary arrangement of the common-address electrode lines A₁ through Aₙ, taken along a line V-V shown in FIG. 5. Referring to FIG. 6, the electrode lines A₁ through Aₙ are formed in a ladder shape. Also, FIG. 7 is a schematic diagram of an exemplary arrangement of the scan electrode lines S₁−Sₘ, taken along a line VI-VI shown in FIG. 5. Referring to FIG. 7, the electrodes S₁ through Sₘ have a ladder shape.

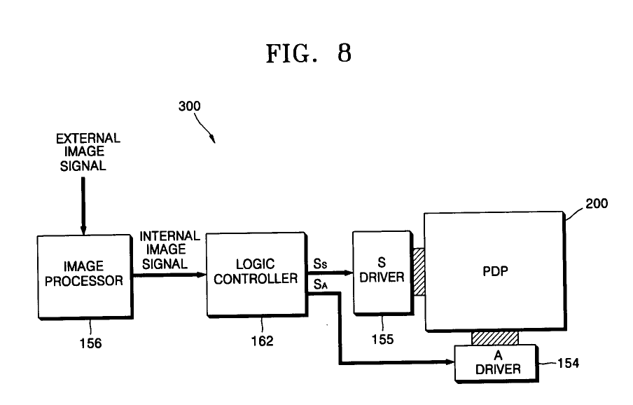

FIG. 8 is a block diagram of a plasma display device 300 including the PDP illustrated in FIG. 4, according to an embodiment of the present invention.

Referring to FIG. 8, the plasma display device 300 includes the PDP 200, an image processor 156, a logic controller 162, an A driver 154, and a S driver 155.

The plasma display device 300 can further include an image processor 156. In one embodiment, the image processor 156 converts an external analog image signal into a digital signal, and generates internal image signals, for example, red (R), green (G), and blue (B) image data each having 8 bits, a clock signal, and vertical and horizontal synchronization signals. The logic controller 162 generates driving control signals SA and SS based on the internal image signals received from the image processor 156.

The A driver 154 processes an A driving control signal SA received from the logic controller 162 so as to generate display data signals, and applies the generated display data signals to the common-address electrode lines A₁ through Aₙ. The S driver 155 processes a S driving control signal SS received from the logic controller 162 to apply an S driving signal to the scan electrode lines S₁ through Sₘ.

In the plasma display device 300, since only two drivers (that is, the S driver 155 and A driver 154) are used to drive the PDP 200, the PDP structure is simplified compared to the conventional structure requiring three drivers.

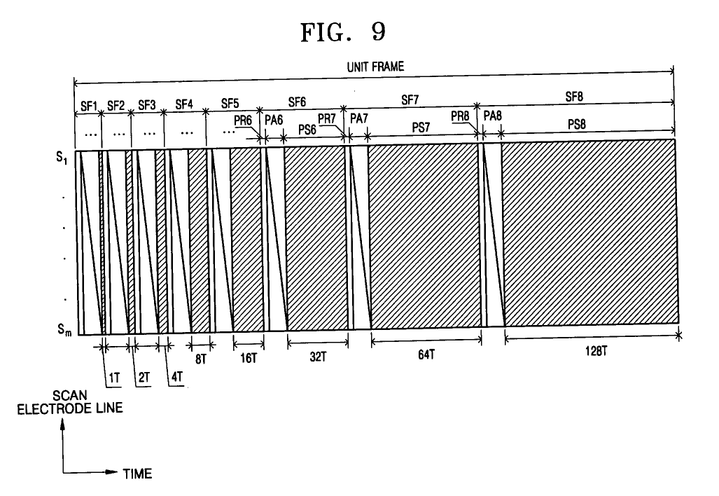

FIG. 9 is a timing diagram for explaining an embodiment of a driving method of the PDP illustrated in FIG. 4. Referring to FIG. 9, each unit frame is divided into 8 sub-fields SF1 through SF8 in order to achieve time-division gradation display. Also, each of the sub-fields SF1 through SF8 is divided into a reset period PR1 through PR8, an addressing period PA1 through PA8, and a sustain-discharge period PS1 through PS8, respectively.

In the reset periods PR1 through PR8, the discharge conditions of all display cells become the same in order to stably perform the following addressing.

In the address periods PA1 through PA8, display data signals are applied to the common-address electrode lines A₁ through Aₙ and simultaneously corresponding scan pulses are sequentially applied to the respective scan electrode lines S₁ through Sₘ. Thus, an address discharge is generated in discharge cells to which display data signals with a high level are applied while the scan pulses are being applied, so that wall charges are formed in the corresponding discharge cells and no wall charge is formed in the remaining discharge cells.

In the sustain-discharge periods PS1 through PS8, in the state that all the common-address electrode lines A₁ through Aₙ are maintained at the ground voltage VG, a sustain-discharge pulse is alternately applied to all the scan electrode lines S₁ through Sₘ, so that sustain discharge is generated in the discharge cells in which wall charges have been formed during the corresponding addressing periods PA1 through PA8. As a result, the brightness of a PDP is proportional to the total length of sustain-discharge periods PS1 through PS8 in a unit frame. The total length of sustain-discharge periods PS1 through PS8 in a unit frame is 255T (T is a unit time). Accordingly, 256 gray-levels including a zero gray-level, not to be displayed on a screen, can be realized.

Here, the sustain-discharge period PS1 of the first sub-field SF1 is set to a time 1T corresponding to 0, the sustain-discharge period PS2 of the second sub-field SF2 is set to a time 2T corresponding to 1, the sustain-discharge period PS3 of the third sub-field SF3 is set to a time 4T corresponding to 2, and the sustain-discharge period PS8 of the eighth sub-field SF8 is set to a time 128T corresponding to 7. Accordingly, by appropriately selecting sub-fields to be displayed among the 8 sub-fields SF1 through SF8, 256 gray-levels including a zero gray-level can be displayed.

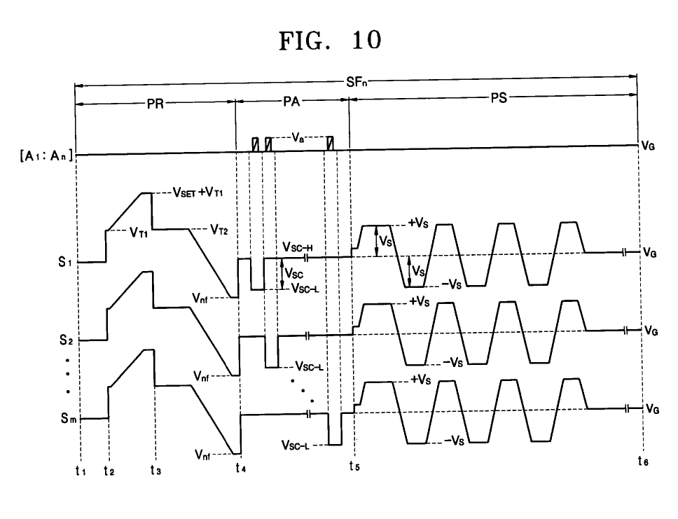

FIG. 10 shows signals applied to electrode lines of the PDP 200 in a unit sub-field SFₙ of FIG. 9. In FIG. 10, a reference symbol [A₁:Aₙ] represents a driving signal applied to common-address electrode lines and a reference symbol Sm represents a driving signal applied to scan electrode lines S₁ through Sₘ.

When a discharge is performed, in a reset period PR, a reset signal is applied to the scan electrode lines S₁ through Sₘ so as to compulsively perform a write discharge, thereby initializing the states of wall charges in all cells. Since the reset period PR is performed over the entire screen before entering the following address period PA, wall charges can be uniformly distributed in all cells. The cells initialized during the reset period PR will have similar wall charge conditions. In the reset period PR, a rising ramp pulse (between t₂ and t₃) is applied to the scan electrode lines S₁ through Sₘ and thus a weak discharge is once generated, so that a large number of negative charges are accumulated on the scan electrode lines S₁ through Sₘ and positive charges are accumulated on address electrode lines and X electrode lines.

Successively, a falling ramp pulse (between t₃ and t₄) is applied to the scan electrode lines S₁ through Sₘ and thus a weak discharge is twice generated, so that a voltage of the scan electrode lines S₁ through Sₘ gradually falls and negative charges accumulated on the scan electrode lines S₁ through Sₘ gradually disappear toward discharge spaces. Due to the weak discharge in the discharge spaces, the discharge cells are initialized.

In one embodiment, while the falling ramp pulse is applied to the scan electrode lines S₁ through Sₘ, if no positive bias voltage is applied to the common-address electrode lines A₁ through Aₙ, the voltage of the scan electrode lines S₁ through Sₘ falls to a very low voltage V_{nf} for initialization discharge of the X electrode lines and the scan electrode lines S₁ through Sₘ. Accordingly, in a following address period PA, a voltage less than the ground voltage VG is applied to the scan electrode lines S₁ through Sₘ. However, it is also possible to apply a positive bias voltage V_{b} to the common-address electrode lines A₁ through Aₙ when the falling ramp pulse is applied.

The rising ramp pulse (between t₂ and t₃) once generating a weak discharge is applied to scan electrodes S₁ through Sₘ, from a voltage greater by a predetermined voltage V_{T1} than a reference voltage. If the rising ramp pulse (between t₂ and t₃) is applied from a voltage greater by a voltage V_{S} of a scan pulse than the reference voltage, since no ramp-up pulse generating circuit is required in addition to a power supply and a switching circuit for generating the scan pulse, manufacturing cost can be reduced. The falling ramp pulse (between t₃ and t₄) is applied to the scan electrodes S₁ through Sₘ, from a voltage greater by a predetermined voltage V_{T2} than the reference voltage. Likewise, if the falling ramp pulse is applied from a voltage greater by the voltage V_{S} of the scan pulse than the reference voltage, since no ramp-down pulse generating circuit is required in addition to the power supply and the switching circuit for generating the scan pulse, the manufacturing cost can be reduced.

In the following address period PA, a scan pulse with a scan high voltage V_{SC-H} is applied to a plurality of scan electrodes. If a scan pulse with a scan low voltage V_{SC-L} less than the scan high voltage V_{SC-H} is sequentially applied to the respective scan electrodes to which the scan pulse with the scan high voltage V_{SC-H} has been applied, corresponding address electrodes are turned on at the same time to select display cells, a large number of negative charges are discharged near the Y electrodes of the selected display cells, and a large number of positive charges are discharged near the address electrodes of the selected display cells, thereby generating an address discharge. Accordingly, a large number of positive charges are accumulated near the scan electrodes to prepare sustain-discharge.

After the address period PA is performed, in a following sustain-discharge period PS, an alternate sustain pulse switching between a positive sustain voltage +V_{S} and a negative sustain voltage −V_{S} is alternately applied to the scan electrode lines S₁ through Sₘ.

The sustain pulse is applied after the positive charges are accumulated on the scan electrode lines S₁ through Sₘ and the negative charges are accumulated on the common-address electrode lines A₁ through Aₙ. In the sustain-discharge period PS, a voltage rising toward the positive sustain voltage +Vₛ is applied to the scan electrode lines S₁ through Sₘ, so that the positive charges accumulated on the scan electrode lines S₁ through Sₘ and the negative charges accumulated on the common-address electrode lines A₁ through Aₙ are discharged as spatial charges and a weak discharge is generated due to the spatial charges. Then, when the rising voltage reaches the positive sustain voltage +V_{S}, more positive charges are discharged as spatial charges from the scan electrode lines S₁ through Sₘ and more negative charges are discharged as spatial charges from the common-address electrode lines A₁ through Aₙ, so that a fast and strong sustain discharge is performed. Such fast and strong sustain discharge (hereinafter, referred to as a first sustain discharge) is generated when a difference (that is, the sum of the absolute values of all voltages) between the sum of the voltage +Vₛ and a voltage created by the positive charges accumulated near the scan electrode lines S₁ through Sₘ, and a voltage created by the negative charges accumulated near the common-address electrode lines A₁ through Aₙ, exceeds a discharge start voltage.

After the first sustain discharge is generated, negative charges are accumulated near the scan electrode lines S₁ through Sₘ and positive charges are accumulated near the X electrode lines.

Successively, a voltage falling toward the negative sustain voltage −V_{S} is applied to the scan electrode lines S₁ through Sₘ. Thus, positive charges are discharged as spatial charges from the common-address electrode lines A₁ through Aₙ and negative charges are discharged as spatial charges from the scan electrode lines S₁ through Sₘ. When the falling voltage reaches the negative sustain voltage −V_{S}, a second sustain discharge is performed. Such second sustain discharge is generated when a voltage (that is, the sum of the absolute values of all voltages) obtained from subtracting the sum of the voltage −Vₛ and a voltage created by the negative charges accumulated near the scan electrode lines S₁ through Sₘ from a voltage created by the positive charges accumulated near the common-address electrode lines A₁ through Aₙ, exceeds a discharge start voltage. After the second sustain discharge is generated, like the state before the first sustain discharge is generated, positive charges are accumulated near the scan electrode lines S₁ through Sₘ and negative charges are accumulated near the X electrode lines. Thereafter, a third sustain discharge is generated by the same process as the first sustain discharge and then a fourth sustain discharge is generated by the same process as the second sustain discharge. The alternate sustain pulse is applied during periods assigned to the respective sub-fields to maintain the sustain discharge.

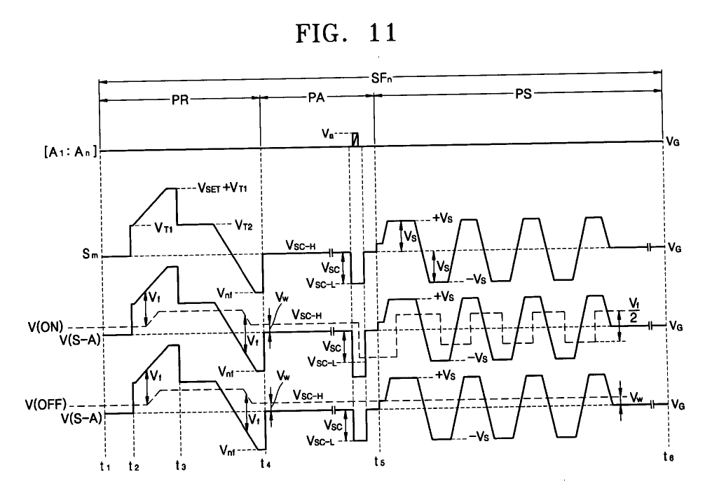

FIG. 11 illustrates the waveforms of the signals applied to the electrode lines in a sub-field and wall voltage distributions of turned-on cells and turned-off cells, according to an embodiment of a driving method of the PDP illustrated in FIG. 4.

In the following description, the slopes and amplitudes of driving signal waveforms are defined considering wall voltages created by wall charges.

A waveform diagram (hereinafter, referred to as a first waveform diagram) illustrated in the most upper portion of FIG. 11 shows a voltage waveform when a display data signal with a data voltage Vₐ is applied to the common-address electrode lines A₁ through Aₙ. A waveform diagram (hereinafter, referred to as a second waveform diagram) illustrated below the first waveform diagram of FIG. 11 shows a waveform of an S driving signal applied to an m-th scan electrode line Sₘ. A waveform diagram denoted by a reference symbol V(S-A) in FIG. 11 shows a waveform illustrating a voltage difference between a driving signal applied to scan electrodes and that applied to common-address electrodes. A waveform diagram denoted by a reference symbol V(ON) in FIG. 11 shows a waveform illustrating a wall voltage when a discharge cell is turned on. A waveform diagram denoted by a reference symbol V(OFF) shows a waveform illustrating a wall voltage when a discharge cell is turned off.

Referring to FIG. 11, in a reset period PR, a rising ramp pulse (between t₂ and t₃) is applied to scan electrode lines S₁ through Sₘ to perform first initialization discharge and then a falling ramp pulse (between t₃ and t₄) is applied to the scan electrode lines S₁ through Sₘ to perform second initialization discharge. The first initialization discharge is performed by applying a rising ramp pulse (between t₂ and t₃) with a gradual slope to the scan electrode lines S₁ through Sₘ. Accordingly, a weak discharge is generated and negative charges are accumulated near the scan electrodes S₁ through Sₘ (that is, near a dielectric layer on the scan electrodes S₁ through Sₘ). In one embodiment, in order to reduce the time t₂-t₃ for the first initialization discharge, the rising ramp pulse is applied from the second voltage V_{T1} and rises to the first voltage V_{SET}+V_{T1}.

The second initialization discharge is performed by applying a falling ramp pulse to the scan electrode lines S₁ through Sₘ, so that negative charges accumulated near the scan electrode lines S₁ through Sₘ (that is, near a dielectric layer on the scan electrode lines S₁ through Sₘ) are discharged and a weak discharge is generated. At this time, the falling ramp pulse applied to the scan electrode lines S₁ through Sₘ should have a gradual slope not allowing a strong discharge.

The falling ramp pulse may have a slope generating the second initialization discharge when a wall voltage greater by a characteristic discharge start voltage V_{f} (which will be described later) than the voltage of the falling ramp pulse is maintained. The falling ramp pulse may be applied after the first voltage V_{SET}+V_{T1} falls to the third voltage V_{T2} in order to reduce the time t₃ and t₄ for the second initialization discharge.

In a following address period PA, a scan pulse of a scan low voltage V_{SC-L} is sequentially applied to a plurality of scan electrode lines S₁ through Sₘ which are maintained at a scan high voltage V_{SC-H}, and a display data signal with a data voltage Vₐ is selectively applied to common-address electrode lines A₁ through Aₙ intersecting the scan electrode lines S₁ through Sₘ to which the scan pulse is applied. Thus, an address discharge is generated in discharge cells to which the display data signal with the data voltage Vₐ is applied, and no address discharge is generated in the remaining discharge cells to which no display data signal is applied.

Then, in a following sustain discharge period PS, an alternate sustain pulse is applied to the scan electrode lines S₁ through Sₘ. Accordingly, the discharge cells to which the display data signal with the data voltage Vₐ has been applied during the address period PA are address-discharged, thus turned on, and sustain-discharged. However, the remaining discharge cells to which no display data signal has been applied during the address period PA are not address-discharged, thus turned off, and not sustain-discharged.

Meanwhile, in the discharge cells of the PDP 200, a strong discharge occurs when a predetermined threshold voltage is generated between electrodes of the discharge cells, wherein the predetermined threshold voltage is referred to as a characteristic discharge start voltage V_{f}. In detail, the strong discharge is generated in the discharge cells when the sum of a wall voltage V(ON) created by wall charges accumulated on the barrier rib and a voltage difference between a signal applied to the common-address electrodes and that applied to the scan electrodes, exceeds the characteristic discharge start voltage V_{f}.

However, since one scan signal and one address signal are applied to each discharge cell of the PDP 200 according to one embodiment of the present invention, a voltage difference between only two electrodes is considered. Therefore, in the plasma display panel including two electrodes, according to one embodiment of the present invention, a characteristic discharge start voltage of the reset period, a characteristic discharge start voltage of the address discharge period, and a characteristic discharge start voltage of the sustain-discharge period are all the same.

Meanwhile, referring to the wall voltage waveform denoted by the reference symbol V(ON) in FIG. 11, in a sustain-discharge period PS, an alternate sustain pulse voltage Vₛ applied to scan electrode lines S₁ through Sₘ of selected discharge cells is greater than half (that is, V_{f}/2) a characteristic discharge start voltage, in order to stably generate a sustain-discharge.
Vₛ>V_{f}/2 (1)

As described above, since a falling ramp pulse applied to scan electrode lines S₁ through Sₘ has a gradual slope and is not generating a strong discharge, a voltage of the discharge cells falls with the gradual slope in the state that a wall voltage greater by the characteristic discharge start voltage V_{f} than a lowest voltage V_{nf} is maintained while the falling ramp pulse is being applied.

After the falling ramp pulse is applied, the discharge cells are maintained at an after reset wall voltage V_{w} greater by the characteristic discharge start voltage V_{f} than the magnitude of the lowest voltage V_{nf} of the falling ramp pulse. The after reset wall voltage V_{w} is continuously maintained in the sustain discharge period PS if no corresponding discharge cell is selected (that is, if no address discharge is generated).

Here, the after reset wall voltage V_{w} can be expressed by Equation 2.
V_{w}=V_{f}−V_{nf} (2)

In one embodiment, in order to prevent a wrong discharge from being generated in non-selected discharge cells during the sustain-discharge period PS due to the after reset wall voltage V_{w}, the after reset wall voltage V_{w} is advantageously less than half the characteristic discharge start voltage V_{f}.
|V_{w}|<V_{f}/2 (3)

In one embodiment, in the non-selected discharge cells, the sum of the after reset wall voltage V_{w} and the alternate sustain pulse voltage Vₛ is advantageously less than the characteristic discharge start voltage V_{f}.
|V₅|+V_{w}<V_{f} (4)

For example, when a second sustain pulse is applied to the non-selected discharge cells, a wrong discharge does not occur if Vₛ+V_{w}<V_{f}. Because V_{w}=V_{f}−V_{nf} (Equation 2), the following inequality 5 is obtained.
Vₛ+(V_{f}−V_{nf})<V_{f},
thus, V_{nf}>Vₛ (5)

In one embodiment, the minimum voltage V_{nf} of the falling ramp pulse applied during the reset period PR is greater than the voltage Vₛ of the alternate sustain pulse applied during the sustain discharge period PS.

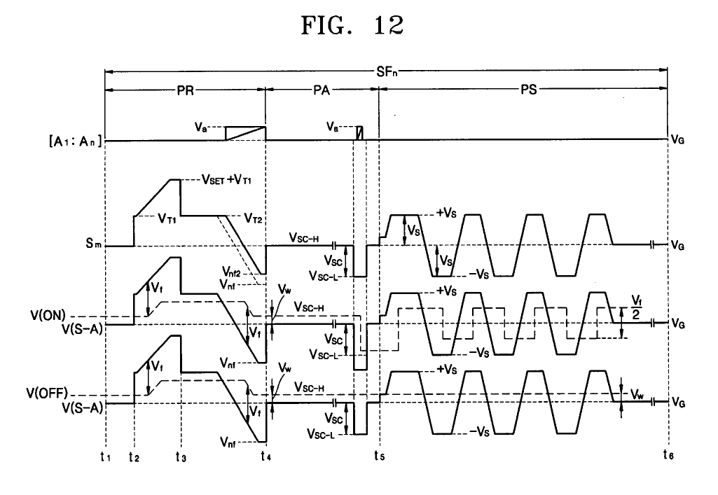

FIG. 12 illustrates a waveform for explaining a PDP driving method according to another embodiment of the present invention. Referring to FIG. 12, a bias voltage Vₓ (not shown) equal to the voltage Vₐ of a display data signal applied during an address period PA, is applied to common-address electrode lines A₁ through Aₙ to facilitate second initialization discharge when a falling ramp pulse is applied to scan electrode lines S₁ through Sₘ.
Vₓ=Vₐ (6)

As such, if a bias voltage Vₓ equal to the voltage Vₐ of a display data signal is applied to the common-address electrode lines A₁ through Aₙ when the second initialization discharge is performed, since a power supply circuit used for manufacturing a driver circuit for driving the common-address electrode lines A₁ through Aₙ is simplified, the manufacturing cost of an address driver can be reduced.

Accordingly, V_{nf}=V_{nf2}−Vₓ=V_{nf2}−Vₐ, and V_{nf} can be rewritten by the following Equation 7.
|V_{nf}|=V_{nf 2}|−|Vₐ| (7)

Meanwhile, in an address period PA, address discharge is generated when the sum of the voltage V_{SC-L} of a scan pulse, the voltage Vₐ of the display data signal, and a wall voltage V_{w} created by accumulated wall charges, exceeds the characteristic discharge start voltage V_{f}. Accordingly, the following inequality 8 is obtained.
|V_{SC-L}|+Vₐ+V_{w}>V_{f} (8)

Also, the inequality (8) can be rearranged to inequality 9 using V_{w}=V_{f}−V_{nf}(Equation 2).
|V_{SC-L}|+Vₐ+V_{f}−V_{nf}>V_{f},
thus, |V_{SC-L}|+Vₐ>V_{nf} (9)

The inequality 9 can be rearranged to inequality 10 using |V_{nf}|=|V_{nf 2}|−|Vₐ| (Equation 7).
|V_{SC-L}|+|Vₐ>|V_{nf 2}|+Vₐ
thus, |V_{SC-L}|>V_{nf 2}| (10)

In one embodiment, if the bias voltage Vₓ equal to the voltage Vₐ of the display data signal is applied to the common-address electrode lines A₁ through Aₙ when the second initialization discharge is performed by the falling ramp pulse applied during the reset period PR, the magnitude |V_{nf 2}| of the lowest voltage V_{nf} of the falling ramp pulse is advantageously less than the magnitude |V_{SC-L}| of the voltage V_{SC-L} of the address pulse applied for selecting discharge cells during the address period PA. Also, the magnitude |V_{nf 2}| of the lowest voltage V_{nf2} of the falling ramp pulse applied during the reset period PR becomes less than the voltage Vₛ of an alternate sustain pulse to be applied during a following sustain discharge period PS.

As described above, in a PDP, according to embodiments of the present invention, the following effects are obtained.

First, since a sustain discharge is generated only in discharge cells partitioned by a barrier rib, it is possible to prevent ion-sputtering of phosphor layers due to charged particles and not to leave a permanent afterimage even when the same image is displayed for a long time.

Second, since a surface discharge is generated from all sides of discharge cells, a discharge area can be expanded.

Third, since discharge generated from all the sides of each of discharge cells is diffused to the center of the discharge cell, a discharge area is significantly widened compared to the conventional PDP and entire discharge cells can be efficiently utilized. Accordingly, low voltage driving is realized and light-emitting efficiency is significantly enhanced.

Fourth, since a driver includes only a scan driver for driving scan electrode lines and an address driver for driving common-address electrode lines without an X driver, manufacturing cost of the driver can be significantly reduced.

Fifth, since a bias voltage applied to common-address electrode lines when a falling ramp pulse is applied to scan electrode lines to generate second initialization discharge, is equal to the voltage Vₐ of a display data signal for addressing in an address period, the number of voltage levels to be applied to the PDP can be reduced, which saves the manufacturing cost of a PDP driving circuit.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel (PDP), comprising:
a first substrate and a second substrate opposite to the first substrate;
a barrier rib, partitioning discharge cells together with the first substrate and the second substrate;
a plurality of common-address electrode lines, embedded in the barrier rib so as to surround the discharge cells, and extending to cross the discharge cells;
a plurality of scan electrode lines, embedded in the barrier rib so as to surround the discharge cells, separated from the common-address electrode lines, and extending to intersect the common-address electrode lines at a respective discharge cell;
a phosphor layer formed in each of the discharge cells; and
wherein the PDP is configured to be driven by a driving waveform including a reset period, an address period, and a sustain-discharge period;
wherein, in the reset period, the PDP is configured to apply a rising ramp pulse to the scan electrode lines to perform a first initialization discharge and apply a falling ramp pulse to the scan electrode lines to perform a second initialization discharge;
wherein, in the address period, the PDP is configured to sequentially apply a scan low voltage (V_{SC-L}) of a scan pulse to a plurality of scan electrode lines which are maintained at a scan high voltage (V_{SC-H}) and selectively apply a display data signal to common-address electrode lines intersecting the scan electrode lines to which the scan low voltage (V_{SC-L}) of the scan pulse is applied;
wherein, in the sustain-discharge period, the PDP is configured to apply an alternate sustain pulse to the scan electrode lines,
and wherein a lowest voltage (V_{nf}) of the falling ramp pulse applied in the reset period is different from a voltage (Vₛ) of the alternate sustain pulse applied in the sustain-discharge period.

2. The PDP of claim 1, wherein the magnitude of the lowest voltage (V_{nf}) applied in the reset period is greater than the voltage (Vₛ) of the alternate sustain pulse applied in the sustain-discharge period.

3. The PDP of claim 1, wherein, in the reset period, a bias voltage (Vₐ) with the same voltage as that of the display data signal is applied to the common-address electrode lines when the falling ramp pulse is applied to the scan electrode lines.

4. The PDP of claim 3, wherein the magnitude of the lowest voltage (V_{nf}) of the falling ramp pulse is less than the magnitude of the scan low voltage (V_{SC-L}) of the scan pulse sequentially applied to the scan electrode lines in the address period.

5. The PDP of claim 1, wherein a first discharge is generated in the discharge cells when the sum of a wall voltage created by wall charges accumulated on the barrier rib and a voltage difference between a signal applied to the common-address electrodes and that applied to the scan electrodes, exceeds a characteristic discharge start voltage (V_{f}) of the discharge cells, and
a characteristic discharge start voltage of the reset period, a characteristic discharge start voltage of the address period, and a characteristic discharge start voltage of the sustain-discharge period are all the same.

6. The PDP of claim 5, wherein, in the sustain-discharge period, the voltage (Vₛ) of the alternate sustain pulse applied to the scan electrode lines is greater than half the characteristic discharge start voltage (V_{f}).

7. The PDP of claim 5, wherein the falling ramp pulse applied to the scan electrodes in the reset period has a slope generating the second initialization discharge while a wall voltage greater by the characteristic discharge start voltage (V_{f}) than the voltage of the falling ramp pulse is maintained.

8. The PDP of claim 5, wherein, after the falling ramp pulse is terminated, the discharge cells are maintained at an after reset wall voltage (V_{w}) greater by the characteristic discharge start voltage (V_{f}) than the magnitude of the lowest voltage (V_{nf}) of the falling ramp pulse.

9. The PDP of claim 8, wherein the after reset wall voltage (V_{w}) is less than half the characteristic discharge start voltage (V_{f}).

10. The PDP of claim 8, wherein the sum of the after reset wall voltage (V_{w}) and the voltage (Vₛ) of the alternate sustain pulse is less than the characteristic discharge start voltage (V_{f}).

11. The PDP of claim 1, wherein the barrier rib is made of a dielectric material.
